(19) United States
(12) Patent Application Publication
(10) Pub. No.: US 2011/0282983 A1
(43) Pub. Date: Nov. 17, 2011

(54) Multimedia Communication Device Within Cloud Computing Techniques

(75) Inventors: Yung-Yih Perng, Taipei (TW); Wen-Tsong Shiue, Taipei (TW)

(73) Assignee: ALVAVIEW TECHNOLOGY INC., Taipei (TW)

(21) Appl. No.: 12/779,965

(22) Filed: May 14, 2010

(51) Int. Cl. G06F 15/173; G06F 3/033; G06F 3/01

(52) U.S. Cl. 709/223; 715/700; 345/163

(57) ABSTRACT

The present invention provides an improved multimedia communication device within cloud computing techniques including a display mechanism for multimedia playing; an operation mechanism linking with the display mechanism for interpretation and implementation of the display mechanism; and a servo mechanism linking with the display mechanism for certification program of the operation mechanism and transmission of the list of multimedia service to the display mechanism; thus, the multimedia playing frequency channel located in our server cloud computing is detected at any time and the contents of the frequency channel are updated immediately; not only the needed frequency channel is quick found by an user, but also it ensures that all frequency channels located in our server cloud computing are normally linked by the user.

### BACKGROUND OF THE INVENTION

### (a) Field of the Invention

The present invention relates to an improved multimedia communication device within cloud computing techniques, specifically to a communication device, wherein the multimedia playing frequency channel located in our server cloud computing is detected at any time and the contents of the frequency channel are updated immediately; thus, not only the needed frequency channel is quick found by an user, but also it can ensure that all frequency channels located in our server cloud computing are normally linked by the user.

### (b) Description of the Prior Art

According to the current advanced information technology, the network speed is quickly upgraded, and the multimedia has begun to spread to users via the Internet, but Internet radio and TV frequency channel, mostly a variety of vendors provide their own self-frequency channel for Internet users watching and listening It is not convenient to the users, because they can not, as in previous years, directly adjust the radio frequency channel or select the station, but must manually one by one link to the site and can not quickly find the content.

In addition, as part of the radio frequency channel and TV station broadcast on the network technology is not yet mature (or can not normally play at any time due to network problems), there is often abnormal situation when users use; moreover, although the network speed and constant upgrading of computer performance, most of the user software packages are becoming increasingly large, thus causing the host personal computer and network burden.

### SUMMARY OF THE INVENTION

In view of the defects of the above-mentioned conventional multimedia communication device, the inventor, by the accumulated experience in the industry for many years, develops an improved multimedia communication device, wherein the multimedia playing frequency channel located in our server cloud computing is detected at any time and the contents of the frequency channel are updated immediately; thus, not only the needed frequency channel is quick found by an user, but also it can ensure that all frequency channels located in our server cloud computing are normally linked by the user.

For achieving the above object, the improved multimedia communication device within cloud computing techniques of the present invention includes a display mechanism for multimedia playing; an operation mechanism linking with the display mechanism for interpretation and implementation of the display mechanism; and a servo mechanism linking with the display mechanism for certification program of the operation mechanism and transmission of the list of multimedia service to the display mechanism.

### BRIEF DESCRIPTION OF THE DRAWINGS

FIG. 1 is a schematic view of the basic structure, according to the present invention;

FIG. 2 is a schematic block diagram of the present invention; and

FIG. 3 is a schematic block diagram of the active condition, according to the present invention.

### DESCRIPTION OF MAIN COMPONENT SYMBOLS

Display mechanism 1

Operation mechanism 2

Servo mechanism 3

Processing unit 11

Display screen 12

Output unit 13

Human-computer interface unit 14

Vehicle unit 21

Execution unit 22

Web page service unit 31

Service program unit 32

Net language unit 33

Database unit 34

### DETAILED DESCRIPTION OF THE PREFERRED EMBODIMENTS

For full understanding the objects, features, and effects of the present invention, the detailed description of the present invention through the specific embodiments coordinated with the drawings is provided as following.

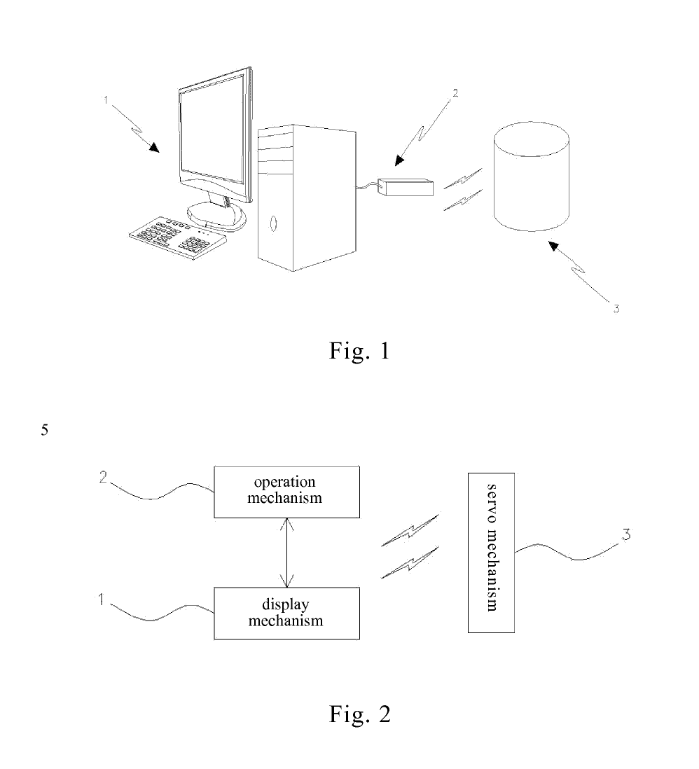

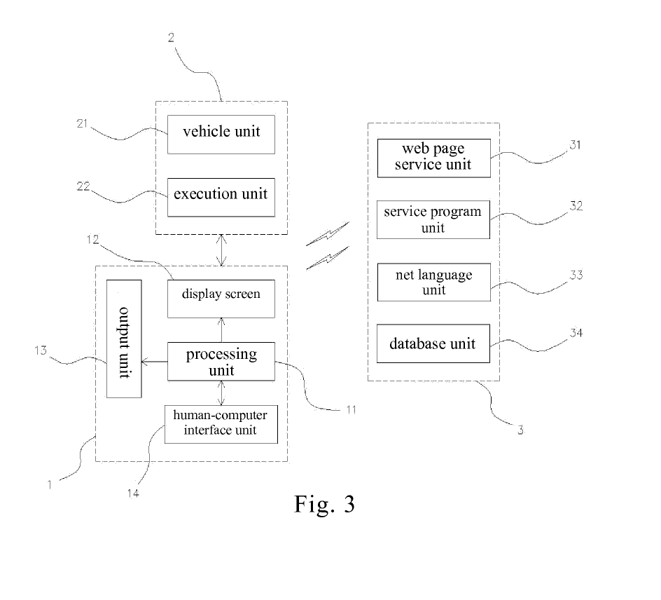

Referring to FIGS. 1, 2, and 3, the schematic view of the basic structure, the schematic block diagram, and the schematic block diagram of the active condition, according to the present invention, respectively. As shown in the drawings, the improved multimedia communication device within cloud computing techniques of the present invention at least includes a display mechanism 1, an operation mechanism 2, and a servo mechanism 3.

The display mechanism 1 is used for multimedia playing, wherein the display mechanism 1 includes a processing unit 11, a display screen 12 connecting with the processing unit 11, an output unit 13 connecting with the processing unit 11, and a human-computer interface unit 14 connecting with the processing unit 11; the output unit 13 is a speaker, the human-computer interface unit 14 is a keyboard, a mouse, or a touch panel, and the display mechanism 1 is a mobile phone, a PC, a Notebook, a Netbook, or any embedded systems.

The operation mechanism 2 linking with the display mechanism 1 is used for interpretation and implementation of the display mechanism 1, wherein the operation mechanism 2 includes a vehicle unit 21, and an execution unit 22 installed within the vehicle unit 21; the vehicle unit 21 is a removable storage device, a compact disk, a hard disk, or a mainframe computer.

The servo mechanism 3 linking with the display mechanism 1 is used for certification program of the operation mechanism 2 and transmission of the list of multimedia service to the display mechanism; wherein the servo mechanism 3 includes a web page service unit 31, a service program unit 32, a net language unit 33, and a database unit 34.

For the application of the present invention, the user can plug the operation mechanism 2 in the connector (not shown) of the display mechanism 1 through the vehicle unit 21, thus the related software media of the execution unit 22 in the operation mechanism 2 can input/output through the processing unit 11 of the display mechanism 1; when the execution unit 22 is activated by the user, the related serial number and verification password are passed to the servo mechanism 3 for verification and then confirmation; if error exists, then error message is passed to the display mechanism 1, and the display mechanism 1 is deactivated; if the effectiveness is confirmed, the execution unit 22 is activated, and the service program unit 32 in the servo mechanism 3 coordinated with the net language unit 33 transmits the search and screening page to the display screen 12 through the web page service unit 31, and then the user selects through the human-computer interface unit 14, in which the screening of the user is performed in the display screen 12 by the continent/country, and the screening information is returned to the service program unit 32 through the web page service unit 31, thus the user can see the list of the required programs played as needed through the service program unit 32; after the user asks to play, the servo mechanism 3 transmits the link URL to the execution unit 22, then, the display screen 12 coordinates with the output unit 13 to link and play; in order to ensure that all frequency channels in the list saw by the user can be linked and played, the servo mechanism 3 will detect the list in the database unit 34 at any time to ensure linking and playing, and the index set architecture of the database unit 34 in the servo mechanism 3 is used to facilitate the user getting the list at fast speed to reduce the waiting time. In addition, only the execution unit 22 is updated when real-time update for the contents of the database unit 34 is performed, thus the amount of the updated data transmission is further reduced, to reduce the bandwidth occupied and the system resources usage for the display mechanism 1.

Different from the conventional technology, the following advantages are achieved during the operation by the user, according to the present invention:

(1) The servo mechanism 3 randomly detects in series all broadcasts and TV programs of the database thereof to ensure that the information of the broadcasts and TV programs can be normally linked and played;

(2) The index set architecture of the database unit 34 is constituted through quick search by the user, direct import of the search criteria, and transmitting to the database located in our server cloud computing 3; because of the index set in the database unit 34, the user can directly search and find out the required multimedia information in the database unit 34 at fast speed; and

(3) Various network application programming interface (API) is developed from the network API provided by well-known website company, such as Google, and coordinated with Alvaview application software, in which asynchronous JavaScript and XML (AJAX) is employed; for example, when the application media map reduces/enlarges, the information is maintained under the premise of not updating the entire page; thus the web application more rapidly responses the user activity, and those unchanged information avoids from being sent on the Internet. Of course, except for Google map, Google translator and YouTube also employ API.

As mentioned above, the present invention completely matches three conditions for patent: uniqueness, unobviousness, and usefulness in the industry. For the uniqueness and unobviousness, the present invention relates to an improved multimedia communication device, in which the multimedia playing frequency channel located in our server cloud computing is detected at any time and the contents of the frequency channel are updated immediately; not only the needed frequency channel is quick found by an user, but also it ensures that all frequency channels located in our server cloud computing are normally linked by the user; for the usefulness in the industry, the products derived from the present invention should fully meet the current needs of the market.

Although the present invention has been disclosed through preferred embodiments in the above description, the skilled in the art should understand that those embodiments are only for describing the present invention but not for limiting the scope of the present invention. It should be noted that, the changes in equivalent of the embodiments fall within the scope of the claims of the present invention as following.

What is claimed is:

1. An improved multimedia communication device within cloud computing techniques, including:
a display mechanism for multimedia playing;
an operation mechanism linking with the display mechanism for interpretation and implementation of the display mechanism; and
a servo mechanism linking with the display mechanism for certification program of the operation mechanism and transmission of the list of multimedia service to the display mechanism.

2. The improved multimedia communication device within cloud computing techniques as claimed in claim 1, wherein the display mechanism includes a processing unit, a display screen connecting with the processing unit, an output unit connecting with the processing unit, and a human-computer interface unit connecting with the processing unit.

3. The improved multimedia communication device within cloud computing techniques as claimed in claim 2, wherein the output unit is a speaker.

4. The improved multimedia communication device within cloud computing techniques as claimed in claim 2, wherein the human-computer interface unit is a keyboard, a mouse, or a touch panel.

5. The improved multimedia communication device within cloud computing techniques as claimed in claim 1, wherein the operation mechanism includes a vehicle unit, and an execution unit installed within the vehicle unit.

6. The improved multimedia communication device within cloud computing techniques as claimed in claim 5, wherein the vehicle unit is a removable storage device, a compact disk, a hard disk, or a mainframe computer.

7. The improved multimedia communication device within cloud computing techniques as claimed in claim 1, wherein the display mechanism is a mobile phone, a PC, a Notebook, a Netbook, or any embedded systems.

8. The improved multimedia communication device within cloud computing techniques as claimed in claim 1, wherein the servo mechanism includes a web page service unit, a service program unit, a net language unit, and a database unit.
